(19) United States
(12) Patent Application Publication
(10) Pub. No.: US 2014/0272912 A1
(43) Pub. Date: Sep. 18, 2014

(54) METHOD OF ONLINE LEARNING FOR MIDDLE SCHOOL CURRICULUM

(71) Applicant: Edison Learning Inc., Pittsburgh, PA (US)

(72) Inventors: Raymond ROZYCKI, McDonald, PA (US); David ZEILER, Pittsburgh, PA (US)

(73) Assignee: Edison Learning Inc., Pittsburgh, PA (US)

(21) Appl. No.: 14/206,080

(22) Filed: Mar. 12, 2014

Related U.S. Application Data
(60) Provisional application No. 61/793,905, filed on Mar. 15, 2013.

(51) Int. Cl. G09B 5/08

(52) U.S. Cl. CPC G09B 5/08
USPC 434/362

(57) ABSTRACT

A comprehensive electronic learning program that evaluates student's learning style preferences and assesses the student's proficiency periodically prior to and/or during an electronic learning course. The information is used to determine subsequent content and supplementary resources for the next section of the course based on the student's learning style preferences.

### CROSS REFERENCE TO RELATED APPLICATIONS

The present application claims benefit to the filing date of Provisional Application No. 61/793,905, filed on Mar. 15, 2013.

### TECHNICAL FIELD OF THE INVENTION

The present invention relates a program that evaluates the learning style preferences of a student and assesses his or her daily proficiency in real time. This information is fed to a proprietary algorithm, which then bundles content and supplementary resources for the next day. The student's responses to assessments are one component of data supplied to the algorithm, which identifies the student's learning zone. If the learning zone indicates that the student will benefit from concept reinforcement or additional activities, the software automatically delivers these to the student. If the student is progressing through activities with ease, the software delivers specific enrichment content that will challenge the student.

### BACKGROUND OF THE INVENTION

E-learning is an inclusive term that describes educational technology that electronically or technologically supports learning and teaching. E-learning includes numerous types of media that deliver text, audio, images, animation and video through technology applications and processes such as computers, local intranet/extranet and the Internet. E-learning can occur in or out of the classroom. It can be self-paced, asynchronous learning or may be instructor-led, synchronous learning. E-learning is suited to distance learning and flexible learning, but it can also be used in conjunction with face-to-face teaching, in which case the term blended learning is commonly used.

Computer-based learning or training (CBT) refers to self-paced learning activities delivered on a computer or handheld device such as a tablet or smartphone. CBT often presents content in a linear fashion, much like reading an online book or manual. Assessing learning in a CBT is often by assessments that can be easily scored by a computer such as multiple choice questions, drag-and-drop, radio button, simulation or other interactive interfaces. Assessments are easily scored and recorded via software, providing immediate end-user feedback and completion status. CBTs provide learning stimulus beyond traditional learning methodology from textbook, manual, or classroom-based instruction. For example, CBTs offer user-friendly solutions for satisfying continuing education requirements. Instead of limiting students to attending courses or reading printed manuals, students are able to acquire knowledge and skills through methods that are much more conducive to individual learning preferences. For example, CBTs offer visual learning benefits through animation or video, not typically offered by any other means. CBTs can be a good alternative to printed learning materials since rich media, including videos or animations, can easily be embedded to enhance learning. CBTs pose some learning challenges. Typically, the creation of effective CBTs requires enormous resources. The software for developing CBTs is often more complex than a subject matter expert or teacher is able to use.

Computer-supported collaborative learning (CSCL) uses instructional methods designed to encourage or require students to work together on learning tasks. Collaborative learning is distinguishable from the traditional approach to instruction in which the instructor is the principal source of knowledge and skills. In contrast to the linear delivery of content, often directly from the instructor's material, CSCL uses blogs, wikis, and cloud-based document portals. With technological Web 2.0 advances, sharing information between multiple people in a network has become much easier and use has increased. Using Web 2.0 social tools in the classroom allows for students and teachers to work collaboratively, discuss ideas, and promote information. After initial instruction on using the tools, students may report an increase in knowledge and comfort level for using CSCL tools. The collaborative tools also prepare students with technology skills necessary in today's workforce.

A learning management system (LMS) is a software application for the administration, documentation, tracking, reporting and delivery of e-learning education courses or training programs. LMSs range from systems for managing training and educational records to software for distributing online or blended/hybrid college courses over the Internet with features for online collaboration. Colleges and universities use LMSs to deliver online courses and augment on-campus courses. Corporate training departments use LMSs to deliver online training, as well as automate record-keeping and employee registration.

Middle School students tend to interpret information literally and concretely, and are typically strong visual learners. A web-based environment is effective in delivering content in various modalities—especially content that is highly visual. Developing an exemplary web-based curriculum involves several critical factors. Three of the most crucial elements in the development of the curriculum are analyzing the research in learning styles of middle school students, applying the research to build the design and framework documents, and implementing the design principals to develop the components of the curriculum.

While multiple factors are required in the development of web-based curriculum, understanding the learning styles of students may be the single most important factor in developing the curriculum. A “learning style” or “learning style preference” is the modality through which the student best learns the subject material. Typically, the learning style is either no preference, visual, auditory or kinesthetic. Research indicates that once a person's learning style is determined, then relying on this modality to teach can greatly increase the likelihood that the person will learn. Although the research shows that most middle school children tend to be visual learners, some learn best using other modalities, which include auditory and kinesthetic. Developing a web-based curriculum that encompasses all three of these modalities ensures the learners' success. Therefore, it is imperative to use a web-based curriculum that provides for learners that are visual, auditory, and kinesthetic.

Exemplary web-based curricula offer both offline and online materials that can be used in any modality of delivery. A highly structured curriculum that gives the students a predictable environment may help middle school children experience success. To create this structure in a web-based curriculum, children generally need to have a consistent schedule, a checklist of activities, short and concise written directions, and color-coded activities or visual elements that identify activities. It is essential to use these principals to design and develop the curriculum components offline and online that allow for this type of consistent structure.

Some middle school children experience difficulties in understanding social communication and social interaction within teams. Using the core learning standards (“I can statements . . . ”) and visual support strategies incorporated in a curriculum allow children to better understand their team environment. Creating a web-based environment in which children can better understand the team, and social elements of our complex world, without the natural consequences, will allow children to experiment with learned social communication.

The aforementioned research principles are essential in building a curriculum, design and framework for an electronic learning platform for middle school students. Therefore, it is with respect to these considerations and others that the present invention has been made.

### SUMMARY OF THE INVENTION

In light of the above, there exists a need to further improve the art. The present invention discloses a system, apparatus and method of customizing electronic learning content to a student's learning style preference where modularized electronic learning content is categorized into learning style preferences, assessments are provided to the student to determine their learning style preferences and modularized electronic learning content is provided to the student based on the student's learning style preferences. In one embodiment, the evaluation of learning style preferences is determined prior to the student taking the course. In another embodiment, the evaluation of learning style preferences are determined while the student is taking the course, and subsequent learning content is modified or selected based on the determined learning style preferences.

The learning style preferences may be either no preference, auditory, visual or kinesthetic, or may be other learning style preferences. The learning style preference of the student may be based on the ratio of a tally of learning style preference categories. The student may also be presented with re-teaching and enrichment modularized electronic learning content based on the learning preference of the student.

### BRIEF DESCRIPTION OF THE DRAWINGS

The figures are for illustration purposes only and are not necessarily drawn to scale. However, the invention itself may best be understood by reference to the detailed description that follows when taken in conjunction with the accompanying drawings in which:

FIG. 1 is a an overview of a first exemplary embodiment of the present invention;

FIG. 2 is a flow chart for placement assessments for students in the middle school program;

FIG. 3 shows one embodiment of a student homepage used for navigating to various aspects of the present invention;

FIG. 4 shows the My Day Planner showing the daily learning activities for the student in one embodiment of the present invention;

FIGS. 5, 6 and 7 show screen shots of progress maps for the student, each providing a different level of detail;

FIG. 8 shows an example of grade breakdown for a student;

FIG. 9 depicts an exemplary screen shot of the My Classroom feature in which a student works on a joint project with other students;

FIGS. 10 and 11 show examples of the My Book application where essential instruction is provided through an interactive story book.

FIG. 12 shows a sample activities workbook;

FIG. 13 shows a sample activities workbook with the answer key;

FIGS. 14 and 15 show exemplary learning activities for students through games;

FIG. 16 depicts an enrichment activity to challenge a student that is easily proceeding through the course work;

FIG. 17 is an example of an algorithm for determining learning style adjustments;

FIG. 18 is a matrix for lessons based on learning style preferences; and

FIGS. 19, 20 and 21 are samples of instructor guides.

### DETAILED DESCRIPTION OF THE INVENTION

Various embodiments will now be described with reference to the accompanying drawings, which form a part of the description, and which show, by way of illustration, specific embodiments. However, this invention may be embodied in many different forms and should not be construed as limited to the specific embodiments set forth herein. Rather, these embodiments are provided so that this disclosure will be thorough and complete, and will fully convey the scope of the invention to those skilled in the art. As described below, various embodiments of the invention may be readily combined without departing from the scope or spirit of the invention.

The Common Core State Standards Initiative is an education initiative in the United States that details what K-12 students should know in English language arts and mathematics at the end of each grade. The initiative is sponsored by the National Governors Association and the Council of Chief State School Officers and seeks to establish consistent education standards across the states as well as ensure that students graduating from high school are prepared to enter two- or four-year college programs or enter the workforce.

The latest educational research shows that middle school students learn best in a highly structured, predictable environment that is individualized and allows some aspects of student choice. Educational research also shows that the middle school student of today, as a “digital native,” demands a degree of digital sophistication that is unique to the present generation.

With this and Common Core Standards in mind, the present invention discloses an exemplary web-based curricula in language arts, social studies, math, and science, preferably for, but not limited to, grades 6, 7 and 8. The curricula, which include online and offline materials, create an informal, engaging environment in which each child can experience success and in which each teacher can feel supported and inspired.

The invention may be typically implemented through software running on a computer, and is implemented within the framework of a LMS and/or learning content development system (CDS). The computer may be any type of client device, including desktop computers, laptop computers, tablet computers, cell phones and any other device. The computer may be capable of establishing a communications link with the Internet, local area network or a wide area network through either a wired medium or wireless medium, and the computer may run an application program enabling the device to perform the programmed algorithms. The application for performing the algorithms of the invention as described below may be implemented on a standalone computer, or maybe implemented through several computers connected via a network. In one embodiment, the algorithms of the invention may be implemented on a central server, where the students access the system through remotely located client devices. In another embodiment, the algorithms of the invention may be implemented by a remotely networked device, for example, through a browser. In yet another embodiment, the server and remote computer will operate in conjunction to implement the invention. The application programs are stored in physical memory devices, such as RAM, ROM, hard-drives, optical drives and any other non-volatile memory devices. The client devices may include application programs that send and receive web-pages, web-based messages, and data packets having content for updating the program and display of the client devices. The client devices may have operating systems that enable the application programs.

A general implementation of the concept of the online learning for middle school curriculum is shown in FIG. 1. The framework of each curriculum consists of Common Core Standards. The courses have been developed to meet or exceed the standards of traditional curricula. The framework of the curriculum may use the global attribute list (GAL) and the common core standards. The GAL standards were created by developing rigorous standards and cross-referencing them with seventeen state standards, and common core standards. The GAL and common core standards were developed to meet or exceed the standards of traditional curricula.

The academic level of students is determined through placement exam 104. The student accesses the system through homepage 106. After accessing the system, the student may be assessed for placement through placement exam 104. This assesses the appropriate grade level for the student, so that the student starts their course work at a level in which they are challenged but does not struggle. Each day the student begins his or her work by starting with My Day 108. My Day 108 displays to the student what he or she will do that day, outlining the tasks in each content area 110. My Day 108 lists the student's responsibilities and assignments. A learning log, available through My Day, provides the student with a visual representation of his or her progress through the curricula. The student can see past activities and tasks completed, as well as items that are not yet completed. Instructional video 120 presents the key concepts of each lesson. The video appeals to students who learn best through audio or visual input. My Book 122 presents information in onscreen text format. Students draw, write, circle, trace, and highlight in My Book 122. These activities appeal to the kinesthetic learner and keep the students engaged. Traditional workbooks 124 use puzzles, matching activities, and upbeat language to reinforce and enrich the online curricula.

While the student is learning online, the LMS monitors his or her responses. A student's responses are one component of data supplied to an algorithm that identifies the student's Learning Zone. The “Learning Zone” is the learning status of the student based on recently completed learning materials. The learning status is an evaluation of how well the student is mastering the subject matter combined with the student's learning style preference. If the Learning Zone indicates that the student will benefit from concept reinforcement or additional activities, the software automatically delivers these to the student as shown by re-teaching 132. If the student is breezing through activities with ease, the software delivers enrichment content 134 that challenges the student. By identifying students' Learning Zones, the curricula keep students engaged and make success attainable for a broad spectrum of learners.

The curricula allow for teacher customization. By using the Teacher Toolbox feature, any teacher can contribute content to be included in the student's My Day checklist. Teacher-contributed activities are presented in a separate section on the student's My Day page. Students see Teacher Toolbox items prior to completing the subject-area learning cycle.

In Writing Center 128, students may submit their essays for review by writing software 130. A student identifies the essay type and reports the number of paragraphs in the essay. Writing Center 128 checks the essay for elements of good writing and makes suggestions about how the student can improve the essay. Video tutorials may be provided to help the student. After a student has made the suggested improvements and submitted the revised essay, the system will read the essay to the student, if desired. When the student is satisfied with his or her work, the student submits the essay to a human grader.

The curricula allow each student to create an avatar and use the avatar to gain rewards—a virtual currency called cogs—each day as shown at 136. Students earn cogs by completing portions of curriculum. In a game world called My Pad, students try, if they wish, to increase their avatar's social status through the use of cogs.

Instructor guide 138 contains daily checklists, directions relating to each activity, summaries and notes about the lesson videos, additional resources, and assignments. The guide assists the educational facilitator who provides the student with structure, assistance, and guidance each day. Each instructor guide begins with an explanation of instructor guide components and definitions and examples of activities.

The web-based curriculum of the present invention incorporates social elements in a fun, safe environment that gives all students an opportunity to succeed.

Placement Exam Structure

In one embodiment, placement exam 104 involves a two-tiered assessment structure presenting the students with “Gateway” questions covering big picture concepts and related “Ancillary” questions covering more specific material. The content of each quarter may tie directly to these two types of questions so there are eight parts (one gateway and one ancillary per quarter) to the placement test. These eight parts may be presented to the student sequentially as long as they continue to demonstrate proficiency on each part, as shown in FIG. 2. To “test out” of the first quarter of Grade 7, the student must first answer all three of gateway questions correctly (100% proficiency) in Part A of the placement test. If 100% proficiency is not accomplished, the assessment will end and the student will be placed in the first quarter of Grade 7. If 100% proficiency is accomplished, the student will be presented Part B of the placement test. In this second part, the student will be presented with the nine ancillary questions covering the major themes in more detail. The nine questions will be scored as a set and the student must answer 8 of the 9 correctly (>88%) to “test out” of Grade 7, first quarter. If 88% proficiency is not accomplished, the assessment will end and the student will be placed in the first quarter of Grade 7. If 88% proficiency is accomplished, the student has tested out of Grade 7, first quarter and the next part of the placement test will open. Part C of the assessment presents the student with three gateway questions written to the content on Grade 7 second quarter. The cycle repeats with 3 gateway questions and 9 ancillary questions for each subsequent quarter. If the student continues to demonstrate proficiency, they would answer a total of 96 questions and test out of the middle school curriculum entirely.

Preliminary Learning Style Assessment

On logging onto the content learning system (My Day), students may be prompted to complete a short assessment. In one embodiment, there may be 15 multiple-choice questions presented to the students, each with three responses. The questions are categorized into the various learning styles. The student's responses are tallied by the system and the system stores the number of times that each learning style was chosen. For example, if the student responded to the 15 questions with 8 auditory responses, 5 visual responses and 2 kinesthetic responses, the system would capture this as a A:V:K ratio as 8:5:2. This ratio will then be analyzed by the system to generate a learning style preference score.

The learning style assessment generates one of the following scores based upon student's responses:

| | |
|---|---|
| No Preference | 1 |
| Auditory | 2 |
| Visual | 3 |
| Kinesthetic | 4 |

To generate one of these scores, the following rules are used:
Rule 1: If the tally finds any one learning style greater than the others, the students will be assigned that learning style score.
Rule 2: If two learning styles have the same value in the tally, the highest learning style score (2, 3 or 4) of the two will be assigned to the student.
Rule 3: If the tally finds an equal number of responses to all three learning styles (5:5:5), the student is assigned No Preference (1) as a learning style.

The following samples show different response ratios and the LSA score generated by the rules above.

| | Auditory | Visual | Kinesthetic | LSA Score | Style | Notes |
|---|---|---|---|---|---|---|
| Sample | 1 | 13 | 1 | 3 | V | Since Rule 1 is met |
| A tally: | | | | | | the student is |
| | | | | | | assigned LSA score |
| | | | | | | 3 - Visual. |
| Sample | 2 | 3 | 10 | 4 | K | Since Rule 1 is met |
| B tally: | | | | | | the student is |
| | | | | | | assigned LSA score |
| | | | | | | 4 - Kinesthetic. |
| Sample | 6 | 6 | 3 | 3 | V | Rule 1 is not met. |
| C tally: | | | | | | Rule 2 applies to |
| | | | | | | ties and compares |
| | | | | | | the LSA scores of |
| | | | | | | Auditory (2) and |
| | | | | | | Visual (3). Since 3 |
| | | | | | | is greater than 2, |
| | | | | | | the student is |
| | | | | | | assigned and LSA |
| | | | | | | score of 3 - Visual. |
| Sample | 9 | 5 | 1 | 2 | V | Since Rule 1 is met |
| D tally: | | | | | | (60.00%) AND |
| | | | | | | Rule 2 is met |
| | | | | | | (26.7%), the most |
| | | | | | | chosen learning |
| | | | | | | style (2-Auditory) |
| | | | | | | is applied to the |
| | | | | | | student. |
| Sample | 5 | 5 | 5 | 1 | NP | Rule 1 and 2 are |
| E tally: | | | | | | not met and Rule |
| | | | | | | 3 applies the No |
| | | | | | | Preference (1) |
| | | | | | | learning style to |
| | | | | | | the student. |

My Day Interface

Each day begins with an activities checklist within the My Day planner, shown in FIG. 4. This checklist serves as a quick-reference guide to the things that each student should accomplish. The checklist cites the day's subject areas and lessons, and includes the learning objects that must be completed. The checklist advises the student if a team activity is accessible that day. Curriculum materials include clear instructions and color-coding that makes the directions easy to follow. The student may be presented with videos, online books, puzzles and activities that encompass the entire curriculum. On completion of the student's curricular tasks they will earn cogs. The students may use the cogs to increase their social status in the “Learning Land”, or choose not to.

The student begins by logging into the software using, for example, a web browser. The log in may be through the use of credentials such as a username and password. Once the student is signed in, the student home page appears, an example of which is shown in FIG. 3. My Day home page 300 shows an overview for the student. Across the top of My Day home page 300 is a series of shortcuts to various pages. Home icon 302 brings the user back to My Day home page 300. Announcements icon 304 provides any system-wide announcements. Each announcement is listed with the date when it was posted, its course, the person who posted it, and a preview of the message. The number of unread announcements appears in the bottom right corner. Messages icon 306 brings the user to the messages page. The messages feature is an internal email application that allows the student to send messages to other students, parents, and instructors within the system. Messages functions just like any typical email program. Forums icon 308 brings the user to the course forums page. My Pad icon 310 brings the user to their optional virtual apartment.

MyDay home page 300 may contain announcements 312, which contains a summary of new or recent announcements. The center of MyDay home page 300 contains My Courses 314 that include MyDay planner 320 and Learning Land 322. The user may click on either icon to be taken directly to each location. Other information 318 contains links for viewing the attendance record, support documentation, the portfolio of the student and the organizations to which the student may belong. Report card 316 shows the current progress and grades of the student in each of their subjects. The report card may contain bar charts for the progress of the student team each of their subjects, and may also show their current grade.

The student access their lessons by clicking on My Day 320, which may open a new browser window containing My Day planner 400 as shown in FIG. 4. My Day planner 400 provides the students with the activities checklist. This checklist serves as a quick reference guide of the things that should be accomplished for a given day's lessons. An item in My Day task list may not be selectable until the previous item in the list has been completed. Therefore, the student must select the first uncompleted item out of all their task lists. This current item may be identified with an animated arrow next to the check box, which summons the student to select it. The student's task list may be composed of items from a single lesson of the appropriate course. For instance, the math task list for a 7th grade student that has completed no work in the course would list the lesson components for Grade 7 Math Lesson 1. The task lists may be individualized for the student and determined by the algorithm for the students learning zone, which is based on the student's past performance. This algorithm may be calculated by the system.

My Day planner 400 is divided by the four main subjects: Math, Science, Social Studies, and Language Arts. These subjects are accessed by tabs 402 through 408. Carousel icon 422 provides a graphical representation each of these four activities, along with a help menu. When the user hovers the mouse icon over any of the activities icons, the underlying icon becomes enlarged and/or rotates the top of the carousel. My Day 400 may also display links to learning log 424, course grade 426 and My Classroom 428. Each subject may have My Achievements 410 which shows the student's current grade, school, parent gifts, total number of cogs and the total number cogs that were earned that day. Each subject may also have a Friends Achievements 412, which provides similar information for friends of the student. For each of the subjects, the students may be presented with lesson video 414, My Book application 416, activities workbook 418, and learning activities 420. The order of items for a task list may vary, and may typically include:

Lesson Video 414—This video may play inside the Course Player. Middle School Lesson Videos may have a final resolution of 800px wide by 450px high. When the student selects one of these in their task list, it may begin to play automatically. When finished playing, it may go back to the My Day task lists with its associated task marked as complete.

My Book 416—This displays the online lesson pages using the visual format of a book. It may use the html parser, with the addition of page turning animation and the same markup tools available to the PDF Viewer (marker, text, eraser, and highlighter). The last page of a My Book may have a button at the bottom marked “Finish” instead of a next arrow.

Activities Workbook 418—The activity workbook may come as a direct URL to a PDF file. It may load within the PDF Viewer. That is, the viewer actually loads an associated .SWF file that has been previously made from the PDF and is located at the exact same URL of the pdf file. Per the upgrades to the PDF Viewer, the student may be able to draw and type on top of the Workbook.

Assessments—A traditional assessment may open in the assessment view. In an alternative embodiment, game assessments display in the game engines.

The learning activities of the students are in self-contained segments, that is, modularized, and may be categorized according to learning preferences. As an example, a video may contain primarily visual teaching tools as opposed to auditory, and thus would be categorized as a visual learning style learning object.

Immediately after a student completes a task, the student may be directed back to the My Day page and display the task being checked off in the task list, an animation of cogs being awarded, and then the completed task dropping into the Done! box. Then the icon gadget may animate the rotation to the next task (placed exactly where it is on the My Day page) as the remaining tasks in the list all slide up so the new currently selected task is at the top of the list. Then the student would need to click the new task (or the icon gadget) to go to it.

Once all tasks in a given subject area have been completed by the student, it may automatically move onto the next subject area with a quick transition animation to visually reward the student and indicate what is occurring. Once all tasks for all subject areas in the My Day list are complete, the “My Day Complete” screen shows congratulating the student on everything they have done and showing them a tally of the cogs that were earned from all of the tasks. It also asks them if they would like to enter the cogs store to with choices of “Yes, go to cogs store” and “No, just go to My Pad.” At the bottom of this screen, there should be a visually non-prominent link that says “Continue onto the next day . . . . ”

The application may contain a teacher tool box where teachers can contribute content they wish to be included in the student's My Day checklist. The Teacher Toolkit feature may be available from a button below the task list on the My Day page, and it may only be displayed if the teacher has posted something to the lesson's Forum. This button may appear directly below the last task in the task list. Clicking the button opens a browser popup window for the student to the lesson's Forum. Additionally, if the Teacher Toolkit button is shown, it may also display the number of posts the teacher had made to the Forum.

Learning Log

Learning log 500, as shown in FIG. 5, is accessed by selecting learning log 424. Learning log 500 is an interactive progress map that is available for the students to view on multiple levels. The learning log details what coursework the students have completed in relation to what they need to complete. Color coding and other user interface elements are used to graphically represent this to the student.

Zooming in and out of the progress map reveals different levels of detail to keep the presentation of information simple, as shown in FIG. 6. For instance, if the student is viewing their entire course year, the learning log user interface would not indicate the task lists for each day. The highest zoom level displays what the student completed for each lesson, shown in FIG. 7. As the student completes lesson tasks, they will be checked off in this view. The most zoomed in level would display the content of a particular task from a previous My Day list. For instance, it may play the lesson video or display the My Book pages of previously completed tasks. A student would only be able to access the content (via the Learning Log) they have already completed, and future My Day tasks may be greyed out to show a student they have not yet reached them.

Course Grade

Course grade 426 displays the current grade for the selected course. Clicking on the button provides a view of the grade breakdown for this course in the screen shown in FIG. 8.

Clicking on My Classroom 428 brings the student to an activity where the student works with other students and combines skills from various subjects. An exemplary screen shot is shown in FIG. 9. For each project, the student selects a role and works with other students in their roles. Like the other regular subjects, each day begins with an activities checklist. This checklist serves as an easy-to-follow guide to the tasks to be accomplished that day. The checklist includes the learning objectives that need to be completed for each lesson and any team activity tasks that must be completed. As the student completes the weekly activities, the work is saved and compiled with that of the student's teammates to produce one theme-based nine-week project that the student receives, for example, as a PDF file. A more detailed description of the My Classroom feature is provided in the co-filed patent application entitled “Collaborative Asynchronous Online Learning, filed based on Provisional Application No. 61/794,957, incorporated herein by reference.

Lesson Videos

In each lesson students will be presented with a lesson video, accessed by clicking, for example, on lesson video 414. Each video presents the key concepts of the lesson. The video lessons are crafted to engage the student with each objective in a clear, fun, and concise method. The videos also serve as reinforcement for the concepts that the student may have found difficult to master.

My Book

The My Book application, accessed through clicking on My Book 416, is an interactive story book that presents essential instruction from the lesson with audio, text, and drawing tools. An example of the My Book page is shown in FIG. 10. My Book serves as a teaching tool that contains objectives parallel to those of the videos, activities workbook, and learning activities. While listening to the audio, the student can use the tools to work with the learning objects that are pertinent to the lesson. In My Book, students are able to switch between one and two column layouts when viewing html content in the course player, an example of which is shown in FIG. 11, by clicking on book icons 1004 and 1006 in My Book markup toolbar 1002.

My Book markup toolbar 1002 allows the student to add annotations to the content of the lesson when prompted to complete an activity. The tools include a marker tool, text tool, line tool, circle tool, highlighter tool, select tool (for moving text boxes) and eraser tool. The students are also able to save or print the annotated PDF to or with their local machine. As the student reads through the pages, the student may be asked to write, highlight, or draw answers to various questions and activities. The system saves the work so the student can go back and review it later on. The student can also access the lesson notepad and even have the lesson read to with these tools. The student can hover the mouse over each icon to find out what it does. When the student reaches the last page of the book, the student may click the green arrow in the lower right corner to mark the book complete and return to the My Day planner. Depending on the lesson, the student may have several My Book tasks in their list. The first one covers the learning objectives for the lesson, while any other tasks review the ideas and present them in different ways to help the student understand. The system may use the student's learning style assessment and how well they are doing in the course to decide how many My Books the student has in each lesson.

Activities Workbooks

The activities workbook use puzzles, matching activities, and upbeat language to reinforce and enrich the objectives of the lesson. An example of an activities workbook is shown in FIG. 12. Students have the ability to complete the workbooks using the online drawing tools, as well as printing the workbook and completing it offline. The activities workbooks have an answer key with each activity. A new tab opens in the browser and displays a PDF file with the correct answers for the activities, as shown in FIG. 13.

Learning Activities

The learning activities create an engaging, interactive, fun and varied assessment platform, evaluating the student's understanding of the material and their growth as they proceed through the curriculum. Assessments may be presented as learning activities, or games, designed to dispel the stress involved in traditional assessment and appeal to student's visually, auditorily and kinesthetically. Examples of learning activities are shown in FIGS. 14 and 15.

Assessments

Assessments are varied, interactive and measure the student's mastery of the subject matter. Assessments may also be categorized into learning style preferences. The nine-week team projects, weekly assessments, daily assessments, and end-of-course assessments focus on engagement. The team projects are designed to measure each student's growth against the core learning skills and mastery of the nine-week course material. The weekly assessments allow the instructors to gauge weekly mastery of the objectives. The daily assessments have been developed as game-based learning activities that help the student master the daily objectives. These assessments focus on the student's writing, reading, science, social studies, and mathematics skills. Students have fun playing the games, and are assessed and tracked through their game playing. Assessments not only monitor the student's progress, but also optimize the curriculum-revision process.

Daily assessments may be presented to the student in the form of mini-games. Every mini-game will have a splash screen, with access to help to explain how the game is played, and a start button that starts the game.

The daily assessments should follow the same forced progression and mastery level logic as will be used in every other assessment in the Course Player. That is, the mastery level will be set on a per course section basis. If the forced progression of a course is true, the student will be required to obtain the score specified in the mastery level parameter to finish the game and complete its associated task in My Day.

The assessment mini-games may need to support only the system-graded question types: multiple choice, multiple answer, matching, and ordering. The games may give the student immediate feedback on their performance in the form of animations and graphics, and may be performed on a per question basis. The student may respond to one question at a time and, in one embodiment, they may not go back to change their answers since they would already be given feedback if there answer was correct or not. To counter-balance this, the student may be given unlimited attempts on all mini-game assessments. If a student exits the game part-way through an assessment, the student's progress may be saved and return them to the first unanswered question in the assessment. The games should not insult the student or make them feel like they have failed or are taking a test. The language should always be positive and be fun enough so the student feels like they are getting better at something by practicing. Sound effects and possibly music may be used to increase the feeling of immersion, but student may be able to disable the game's audio and it may never be mandatory for gameplay. It is okay for the student to feel challenged, but there should never be a sense of frustration. After a session is over, the student should see their results and then immediately be given the option to play again, which corresponds with a new attempt. An assessment is complete when a student stops hitting play again button, no matter what their highest score is. The mini-game assessments may support the mastery level of the course.

The min-games may come in any number of forms. A person climbing a rock wall, where placing the correct answer on a question near a stone allows them to reach the top. Penalty kick for soccer/hockey, where the student chooses an answer that pertains to a certain area of the goal. If the student chooses correctly, the goal goes in and if not, the goalie makes the save. Platform game, where a character has to get from one side of the screen to the other. If the student chooses the correct answer, the character passes an obstacle. If incorrect, the character gets hit and loses a piece of health. If the assessment were 5 questions, there would be 5 pieces of health total. Maze Game, which pertains to the order question type. The student chooses the correct sequence of doors corresponding to the order of the answers for their character to get through a maze. Other potential games include a spaceship game, racing game, weightlifting, throwing darts at water balloons, speedboat game, or a towers assault game where answering questions correctly allows a structure to be bombarded.

When a student is prompted to begin their daily assessment, they will be presented with two different learning activity icons. Both icons will open the same assessment category (i.e. multiple choice), but will give the students variety and individualization in the type of activity used for assessment. When an icon is clicked, the student will be presented with an engaging, animated, content-based activity testing the student's comprehension of the lesson material. The questions stored in the assessment pool manager will be called to these activities randomly in sets of ten questions. The activity will also track the student's responses and send them back to the LMS where it will be determined if each response is correct or incorrect. A score will then be generated and presented to the student at the end of the activity. This score and each assessment attempt will also be sent to the student's grade book.

Cogs earned from any My Day assessment task should vary depending on the assessment score the student receives. If the assessment has multiple attempts, the student should be able to improve upon the cogs earned from the first attempt, but the total amount of cogs earned may not exceed the maximum allowed by the total point value of the assessment. Basically, it should just take the highest score out of all the attempts and award cogs based on that.

The value of cogs the student receives may be calculated by taking the points earned on the current assessment attempt and subtracting the max score of all previous attempts recorded in the gradebook, then taking that net result and multiplying it by the assessment cogs multiplier variable, which may be a configurable item in the Cogs economy. If the score of the current attempt is less than the max score already obtained by the student from previous attempt(s), then the negative result may be rounded to zero and the student may receive no cogs—and not negative cogs. If there are no previous attempts on the assessment, then the max score of all previous attempts recorded in the gradebook should be considered to be 0.

For example, say the cogs multiplier is 1 and the student attempts an assessment for the first time and scores a 4/10. They would receive 4 cogs for their first attempt. They then score a 9/10 on the second attempt. They would receive 5 more cogs at that point since they already received 4 from the first attempt (9−4=5, and 5×1=5). If they scored 8/10 on their third attempt, then they would not receive any more cogs since they did not improve upon their highest score (8−9=−1, which should be rounded to zero). If they then scored a 10/10 on their fourth attempt, they would receive 1 more cog since they improved 1 point on their highest score recorded in the gradebook for that assessment (10−9=1, and 1×1=1). At that point, it would be impossible for them to earn any more cogs from that assessment since they scored the max. The cogs multiplier can be whatever variable based on the economy.

In addition to the assessment cog award system described above, there should be a perfect score bonus awarded if a student scores a 100% on an assessment. This would be calculated by multiplying the total points of an assessment by the perfect score multiplier (should default to 0.2), and then giving that result to the student as cogs (rounded up to the nearest whole number) to be awarded in addition to whatever cogs they earned for the assessment score itself. This perfect score multiplier is another item that should be configurable in the cogs economy.

Learning Zone

Addressing student learning styles is extremely important. Research consistently shows that when the educational process addresses learning styles, academic performance increases. Although most middle school students are visual learners, some are auditory or kinesthetic learners. The system determines a student's learning style and leads him or her to activities and games that fall within that modality. The curriculum is adaptive as well, tracking student progress throughout and adjusting learning styles if students are performing better in one modality than in another.

The determination of the student's Learning Zone is based upon a set of intelligences captured by the LMS/CDS. The Learning Zone gauges when a student is a having a difficult time learning the concepts and provides the students with additional help or activities that are delivered to the student in a just-in-time fashion. Also, if a student is breezing through the activities with ease, this system will deliver content, like the enrichment activity shown in FIG. 16, that helps challenge the student in each lesson. The Learning Zone will level the student with additional content in the way of re-teaching or enriching the student. By identifying students' Learning Zones, the curricula keep students engaged and makes success attainable for a broad spectrum of learners

An example of an algorithm for the learning style adjustment is shown in FIG. 17. The algorithm uses multiple variables in the determination of presentment of re-teaching or enrichment items. The modality number H refers to the learning style preference of the student. In this example, the values are as follows: 1=no tendency; 2=auditory preference; 3=visual preference; 4=kinesthetic preference. The value T is the reteaching number and the value U is the enrichment number. These three values form a three digit code that is used to determine the re-teaching and enrichment items to be presented to the student according, in this example, to the matrix for lessons based on learning style preferences shown in FIG. 18. For example, a student with an undetermined modality may be assigned a modality value of 1. If the value of T were 1 and U was 1, then these values are combined to form the lesson matrix code “111”. The lesson matrix code “111” corresponds to the fourth row in FIG. 18 which shows that the student should be presented with the lesson video, essential instruction My Book, re-teach My Book, enrichment My Book and Assessment.

The algorithm counts the number of assessment attempts C, successes S and failures F. A mastery level M may be set by the institution providing the course, and in this example is set at 80%. If the assessment attempt score A is greater than the master level M, then the successes value S is incremented, otherwise the failure value F is incremented.

If the assessment counter C is less than 7, no adjustment is made to the value of the modality number H. If the percentage of success, as determined by S/(S+F) is below, for example, 60% then the modality number H is set by the cycling function H=(H Mod 4)+1. In effect, the cycling function increments through each of the possible values of H in a cycle. When H is changed, assessment counter C is reset to 0. If the percentage of successes is greater than 60%, then no adjustment is made to H. The value of the lesson matrix code is then set according to the chart shown in FIG. 17. As an example for C=8, S=3, F=5 (corresponding to 8 assessments, 3 successes and 5 failures) and an H=1 (auditory), H would be incremented to 2 because the percentage of successes (3/(3+5)) is less than 60%. The lesson matrix code would be 202 because S-F is equal to −2 satisfying the condition in row 5 of the chart in FIG. 17, which sets T to 0 and U to 2. This algorithm is exemplary and may be altered to provide alternative.

Learning Land

The curriculum engages each student by allowing the students to create an avatar and journey to Learning Land where they may interact with other middle school students. Within this virtual world students will embark on a journey to increase their status in the game world by completing their My Day activities. Students are able to increase their social status in Learning Land by earning and spending cogs at the completion of their courses.

Writing Center

In the Writing Center, a building located in Learning Land, students may submit their essays for review by writing and editing software.

Students are prompted to identify the essay type and number of paragraphs in the essay. The Writing Center system checks the essay for elements of good writing and makes suggestions about how the student can improve the essay. Video tutorials are presented for topics in which the student is identified as needing extra support. After a student has made the suggested improvements and submits the revised essay, the system will read the essay to the student, if desired. When the student is satisfied with his or her work, the student submits the essay to a human grader.

My Pad

My Pad is the name of the student's personal virtual apartment. Students earn cogs by completing their coursework, and can use this virtual currency to buy items from the Cogs Store for their “pad”. Students can directly access their My Pad using a button on their Edison eSchoolware homepage. A student's My Pad room is inside the Apartment Building in the Learning Land environment and can be upgraded with purchases using cogs.

A student's My Pad room may be inside the Apartment Building in the Learning Land environment. The Apartment Building may consist of a Foyer chat room with access to elevators. Clicking an elevator door or button panel may open a menu of the apartments the user has access to. If the user is a teacher or admin, they may access any other user's Pad as long as the student is in it. Students may have the ability to lock and unlock their My Pad room door as they enter it. If the room door is unlocked, student may enter another student's pad if they are friends. Students that are not friends may never enter each other's rooms unless the room's occupant has a special party event. If the room door is locked, only the room's occupant may enter it.

Instructor Guides

The instructor guide is an integral part of the curriculum. Although each part of the curriculum is a necessary component, the instructor guide is the device that connects all of the components together for the instructor. The instructor guide contains information on learning objects in the curriculum, extension activities, and additional practice material, as shown in the samples of FIGS. 19, 20 and 21.

The guide is designed for the educational facilitator who provides the student with structure, assistance, and guidance each day. Each of the guides begins with an explanation of the components in the instructors guide and definitions and examples of activities.

Although other modifications and changes may be suggested by those skilled in the art, it is the intention of the inventors to embody within the patent warranted hereon all changes and modifications that reasonably and properly come within the scope of their contribution to the art.

What is claimed is:

1. A method of customizing electronic learning content to a student's learning style preference in a networked computer system comprising:
categorizing modularized electronic learning content into learning style preferences;
determining a learning style preference for the student based on an assessment of the student provided through the networked system;
selecting modularized electronic learning content to be presented to the student as a consecutive series that forms at least part of course on a subject of learning based on the learning style preference for the student and the learning style preference of the modularized learning content; and
enabling presentation of the modularized electronic learning content forming at least part of the course to the student on a computer display.

2. The method of claim 1 further comprising:
assessing the proficiency of the student for the modularized electronic learning content contained within the course;
determining an updated learning style preference of the student by correlating the proficiency of the student for the modularized learning content with the learning style preferences of the modularized learning content; and
modifying subsequent modularized electronic learning content presented to the student based on the updated learning style preference of the student.

3. The method of claim 1 where the learning style preferences are either no preference, auditory, visual or kinesthetic.

4. The method of claim 2 where determining of the learning style preference of the student is based on the ratio of a tally of learning style preference categories.

5. The method of claim 1 where the determining of the learning style preference of the student occurs prior to the student beginning the course.

6. The method of claim 2 further comprises:
enabling presentation of reteaching and enrichment modularized electronic learning content based on the learning preference of the student.

7. A system for customizing electronic learning content to a student's learning style preference comprising:
a server having access to a database containing modularized electronic content categorized into learning style preferences stored in non-volatile memory;
a network device having a display that is in communication with the server and in conjunction with the server having computer executable instructions stored in a memory device that enable steps including:
determining a learning style preference for the student based on an assessment of the student;
selecting modularized electronic learning content to be presented to the student as a consecutive series that forms at least part of a course on a subject of learning based on the learning style preference for the student and the learning style preference of the modularized learning content; and
presenting the modularized electronic learning content that forms at least part of the course to the student on the display.

8. The system of claim 7, where the network device in conjunction with the server has further executable instructions that enable:
assessing the proficiency of the student for the modularized electronic learning content of the course;
determining an updated learning style preference of the student by correlating the proficiency of the student for the modularized learning content with the learning style preferences of the modularized learning content; and
modifying subsequent modularized electronic learning content presented to the student based on the updated learning style preference of the student.

9. The system of claim 7 where the learning style preferences are either no preference, auditory, visual or kinesthetic.

10. The system of claim 8 where determining of the learning style preference of the student is based on the ratio of a tally of learning style preference categories.

11. The system of claim 7 where the determining of the learning style preference of the student occurs prior to the student starting the course.

12. The system of claim 7, where the network device in conjunction with the server has further executable instructions that enable:
enabling presentation of reteaching and enrichment modularized electronic learning content based on the learning preference of the student.

13. An apparatus having a processor that customizes electronic learning content to a student's learning style preference comprising:
modularized electronic learning content stored in non-volatile memory that is categorized into learning style preferences;
an electronic assessment that determines a learning style preference for the student;
an electronic learning course that contains a consecutive series of modularized electronic learning content;
a learning zone module that determines a learning style preference of the student by correlating the proficiency of the student for the modularized learning content with the learning style preferences of the modularized learning content and modifies subsequent modularized electronic learning content presented to the student based on the learning style preference of the student; and
a means for displaying the course to the student in a computer-based learning environment.

14. The apparatus of claim 13 where the learning style preferences are either no preference, auditory, visual or kinesthetic.

15. The apparatus of claim 13 where the learning zone module determines the learning style preference of the student based on the ratio of a tally of learning style preference categories.

16. The apparatus of claim 13 where the learning zone module enables presentation of reteaching and enrichment modularized electronic learning content based on the learning preference of the student.
